(19) United States
(12) Patent Application Publication
(10) Pub. No.: US 2021/0291402 A1
(43) Pub. Date: Sep. 23, 2021

(54) METHOD AND DEVICE FOR PRODUCING A CONCRETE WORKPIECE

(71) Applicant: Pquadrum Engineering SA, Lugano (CH)

(72) Inventor: Andrea PEDRETTI-RODI, Bellinzonz (CH)

(73) Assignee: Pquadrum Engineering SA, Lugano (CH)

(21) Appl. No.: 17/041,295

(22) PCT Filed: Mar. 25, 2019
(86) PCT No.: PCT/CH2019/050005

§ 371 Date: May 26, 2021

(30) Foreign Application Priority Data
Mar. 26, 2018 (CH) 00396/18

(51) Int. Cl. B28B 7/34; B28B 1/14

(52) U.S. Cl. CPC B28B 7/346; B28B 1/14

(57) ABSTRACT

The invention relates to a method for producing a concrete workpiece (1, 60), wherein fresh concrete is poured into a negative (35, 80) of the workpiece (1, 60), and the concrete at least partly hardens in the negative and is then removed. The invention is characterized in that a positive (5, 71) is produced from me concrete workpiece (1, 60) to be produced, the positive is arranged in a casting formwork (20, 70), and negative fresh concrete is then poured onto the positive. The negative fresh concrete is removed after being at least partly hardened (35, 80), and the concrete body produced in this manner is used as a negative (35, 80) in order to produce the workpiece (1, 60) therein using the fresh concrete poured into the negative (35, 80).

The present invention relates to a method for producing a concrete workpiece according to the preamble of claim 1 and a negative mould for the production of a concrete workpiece according to claim 6.

It is known to pour fresh concrete (i.e. the pourable concrete mixture prior to pouring) into a formwork, which is generally made from wooden slats, and thus to produce simple and large concrete parts. The concrete mixtures available today increasingly allow a refined shaping, which is not only very precise in terms of the dimensions, but rather is also dimensioned in accordance with the operational stress of the concrete workpiece to be produced. Thus, the requirement is developing to be able to produce complex concrete parts in series as well, i.e. concrete parts with a multi-membered or complicated shaping, which until recently was reserved as such for materials other than concrete. Today, this is realized in that casting moulds for the concrete workpiece, i.e. negative moulds, are produced from metal and the fresh concrete is poured into such a negative mould.

It is disadvantageous in such methods, that such negative moulds manufactured from metal are expensive to produce, for example because the machining by the cutting methods and the metal itself are complicated or expensive.

Accordingly, it is the object of the present invention, to create an improved production method for concrete workpieces, primarily for those with complicated shaping.

This object is achieved by means of a method with the features of claim 1 or by a negative mould with the features of claim 6.

As even the negative mould itself is produced from concrete, the complicated processing steps for the shape thereof are dispensed with, wherein the positive mould for producing the negative mould can in turn be produced from an easily workable material, such as wood or plastic, which only insignificantly increases the outlay in relation to the outlay for a negative mould consisting of metal.

Beyond the set object, shapes may also be realized using negative moulds cast from concrete, which cannot be realized or can only be realized with disproportionately large outlay in the case of a negative mould produced from metal.

Further preferred embodiments have the features of the dependent claims.

The invention is also explained in somewhat greater detail hereinafter on the basis of the figures.

In the figures:

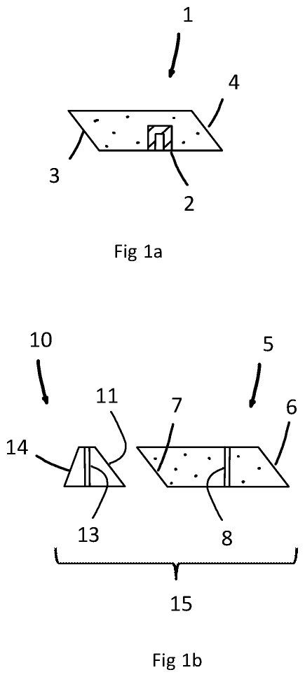

FIG. 1a schematically shows a concrete workpiece in cross section, which should be produced according to the invention

FIG. 1b schematically shows the positive mould of the concrete workpiece in cross section with an associated volumetric body

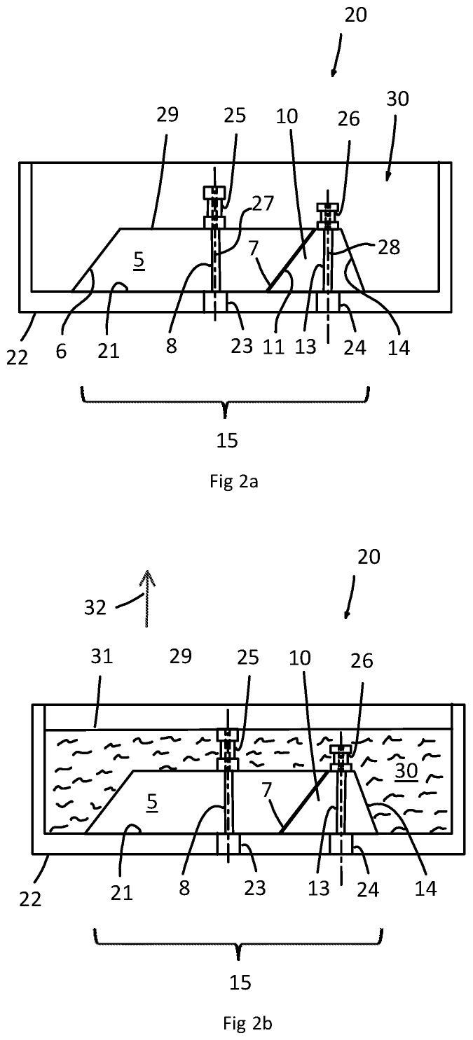

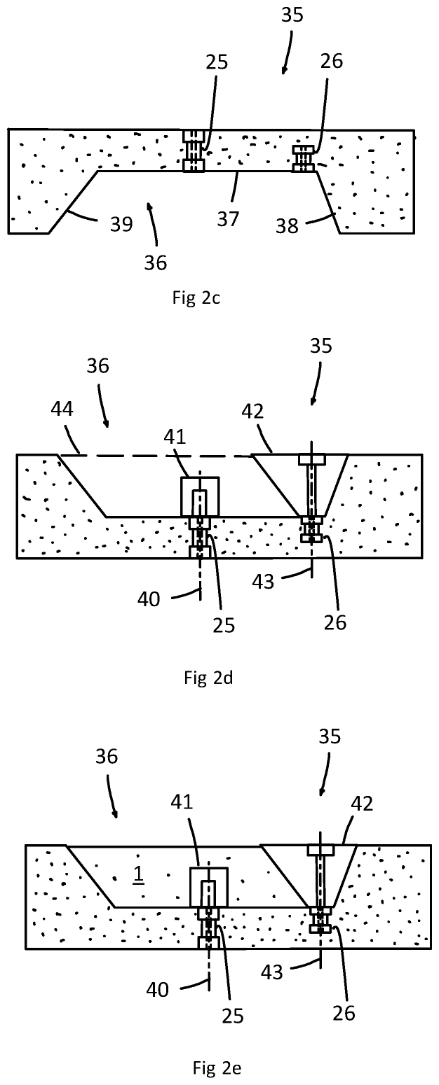

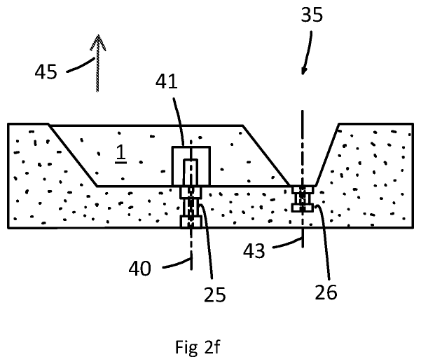

FIG. 2a schematically shows a casting shell, which is equipped ready for pouring, in cross section

FIG. 2b schematically shows the casting shell, with poured negative-mould fresh concrete, in cross section

FIG. 2c schematically shows the negative mould, which is removed from the mould, in cross section

FIG. 2d schematically shows the negative mould, which is equipped for pouring of the fresh concrete, in cross section

FIG. 2e schematically shows the produced concrete workpiece in the negative mould, in cross section

FIG. 2f schematically shows the concrete workpiece in the negative mould, prepared for removal from the mould, in cross section

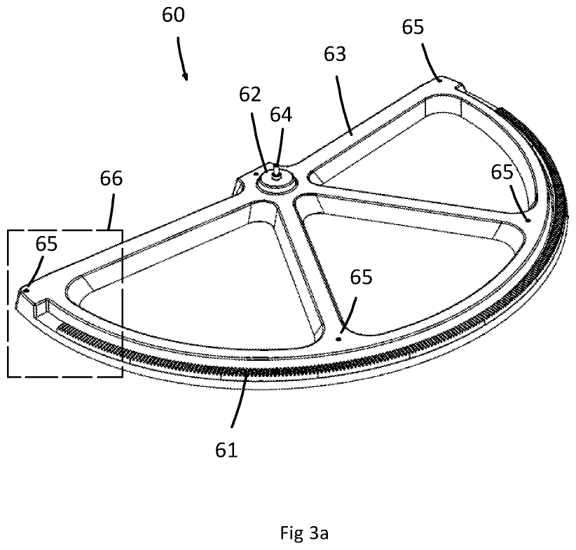

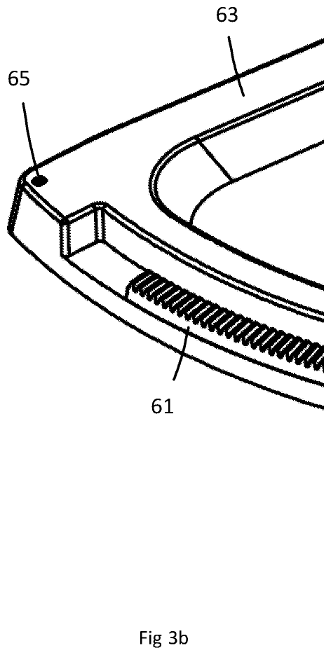

FIG. 3a shows a concrete workpiece to be produced according to the invention, to scale, in the form of a gearwheel,

FIG. 3b shows a detail of the gearwheel of FIG. 3a,

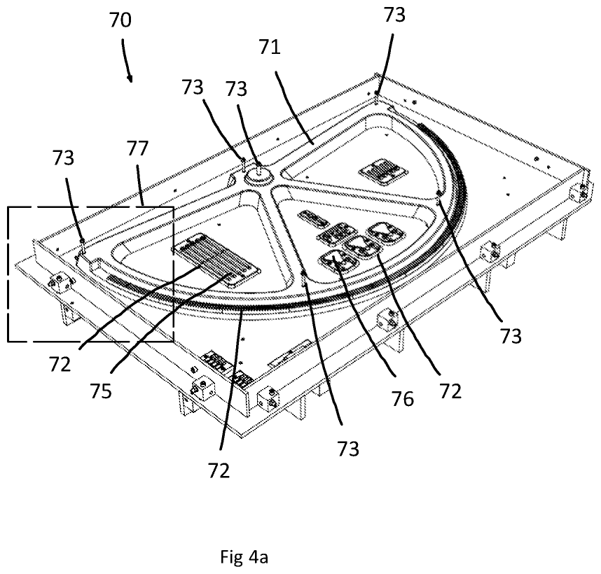

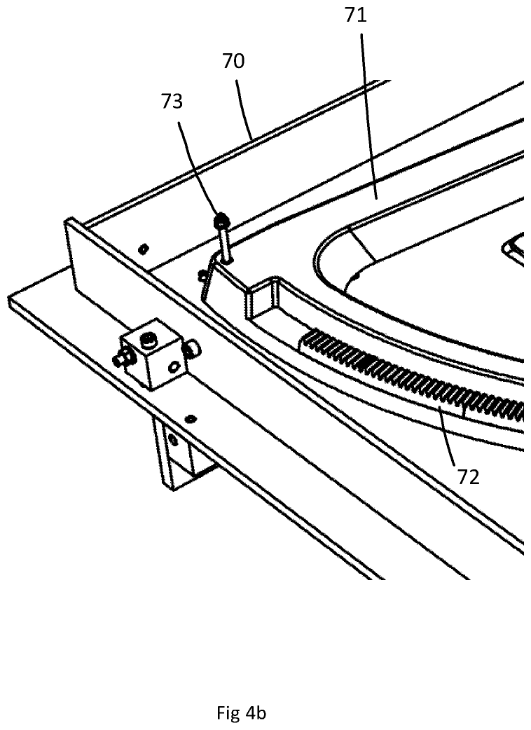

FIG. 4a shows a positive mould of the gearwheel of FIG. 3a, to scale, arranged in a casting formwork,

FIG. 4b shows a detail of the arrangement of FIG. 4a,

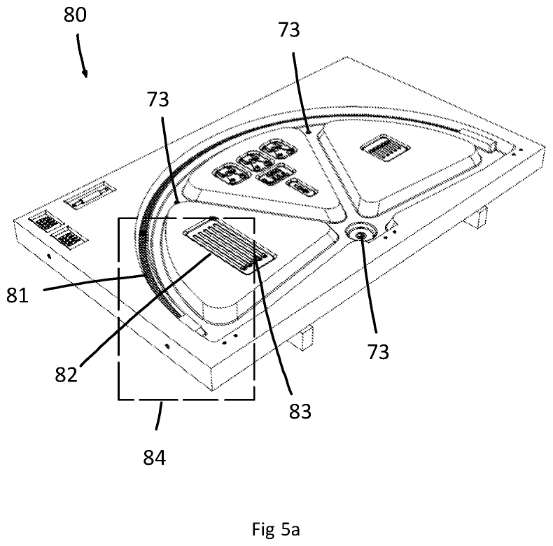

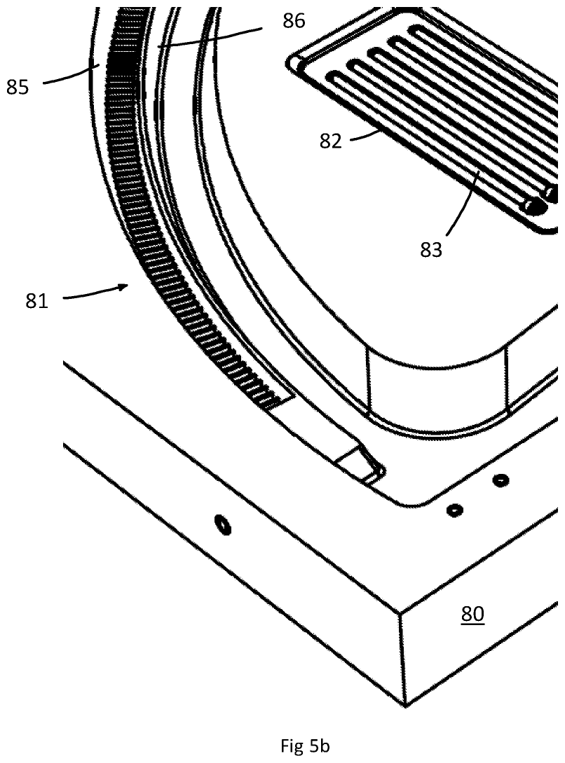

FIG. 5a shows a negative mould according to the invention, to scale, made from concrete for the production of the gearwheel of FIG. 3a, and

FIG. 5b shows a detail of the negative mould of FIG. 5a.

FIG. 1a schematically shows a concrete workpiece 1 to be produced, in cross section, with a cast-in structural element, which is constructed as a threaded bush 2 here, wherein the body of the concrete workpiece 1 has inclined side surfaces 2 and 3. The concrete workpiece is only illustrated by way of example here and represents all possible simple or complicated shapes, which the person skilled in the art wants to produce as a concrete workpiece. Likewise, any desired number of structural elements may be provided, which are constructed differently. The structural element 2 that can be seen here has an internal thread, so that a threaded bolt can be screwed in, which is then securely anchored on the concrete workpiece 1. Alternatively, a bayonet closure is conceivable for example, or if need be a ball bearing—in principle all machine parts that can be cast in may be considered, wherein the castability essentially depends only on the outer shaping of the machine part ensuring a secure fit in the hardened concrete of the concrete workpiece 1.

FIG. 1b shows a positive mould 5 according to the invention, of the concrete workpiece 1, corresponding to the outer contour of the concrete workpiece 1, likewise in cross section. The inclined positive-mould side surfaces 6 and 7 can be seen, which correspond to the side surfaces 3 and 4 of the concrete workpiece 1. A structural channel 8 can further be seen in the positive mould 5, which for example makes it possible to fix structural elements on the positive mould 5, or the positive mould 5 itself on a casting formwork, see the description below to this end. The positive mould 5 is preferably manufactured from wood, but can also consist of plastic, such as nylon or another material. Both materials can be machined easily, complicated and difficult objects can, if necessary, be made from both materials, without the outlay therefor becoming high.

A volumetric body 10 is constructed in such a manner that it can be arranged on a section of the positive mould, here on the side surface 7, here by means of its side surface 11. Then, the volumetric body 10 continues the volume of the positive mould 5, wherein the body 15 composed of the positive mould 5 and the volumetric body 10 accordingly has a new outer contour, here with the side surface 14. The volumetric body 10 is likewise provided with a structural channel 13 here. It is noted here that the volumetric body 10, like the concrete workpiece 1 or the positive mould 5, may be constructed as desired, but always in such a manner that it can continue the volume of the positive mould, adjoining a section thereof. Like the positive mould 5, the volumetric body 10 can also be manufactured from wood or plastic.

FIG. 2a shows a casting formwork 20, which is here constructed as a simple basin which is open at the top. The positive mould 5 and likewise the volumetric body 10, which adjoins the positive mould 5 at a section (here at the side surface 7 thereof, see above) and thus continues the volume thereof, are then inserted into the casting formwork 20 on the inner base surface 21 thereof. For the structural channels 8, 13, openings 23, 24 are provided in the base 22 of the casting formwork 20, which openings allow access to the same. As a result, structural elements 25, 26 provided with internal threads can for example be fixed by means of threaded bolts, symbolized by the dot-dashed lines 27, 28, on the upper outer side 29 of the positive mould 5 and the volumetric body 10, from the side of the base 22. This fixing simultaneously fixes the positive mould 5 and the volumetric body 10 on the casting formwork 20.

Preferably, the casting formwork 20, which is generally constructed as a simple basin, consists of metal, whether this is iron or aluminium. Owing to the simple shape, the outlay for a metallic casting formwork 20 is of no considerable consequence.

FIG. 2b shows the casting formwork 20 equipped according to FIG. 1c, which is filled with negative-mould fresh concrete 30 up to the line 31, so that although the structural element 25 is cast in, it is not covered. Negative-mould fresh concrete 30 is a concrete mixture which is used for the concrete negative mould to be produced and which may be different from the concrete mixture for the workpiece 1 (FIG. 1) and is accordingly termed negative-mould fresh concrete. Depending on the concrete mixture(s) used, the person skilled in the art may provide a separation layer, for example wax, between the positive mould and the negative-mould fresh concrete.

After the at least partial hardening of the negative-mould fresh concrete 30, i.e. up to a hardness, which allows removal from the casting formwork 20, removal from the mould takes place in the corresponding mould-removal direction 32. To this end, the connection between the base 22 and the structural elements 25, 26 (and the positive mould 5 and the volumetric body 10) must be detached, which may be done easily by means of the openings 23, 24. The result is that structural elements 25 are arranged on the positive mould 5 in a detachable manner, which encloses the negative-mould fresh concrete during casting, and wherein the structural elements 25 are detached from the positive mould 5 in such a manner for the removal of the negative mould 35 from the casting formwork 20 that the structural elements 25 remain in the negative mould 35.

FIG. 2c shows the concrete body after removal from the mould, i.e. the negative mould 35 with the cast-in structural elements 25, 26 which only partially corresponds to the positive mould 5 and therefore the concrete workpiece 1 to be produced, however: the negative mould 35 has a casting cavity 36 for the concrete body, with the base 37 and the side walls 38, 39, which is too large around the volumetric body 10.

However, it is easy to see that without the volumetric body 10, the positive mould 5 and the negative mould 35 could not have been separated from one another, see FIG. 2b: without the volumetric body 10, the incline of the side surface 7 of the positive mould 5 would not allow a separation of the positive mould 5 from the set concrete 30. Therefore, in the embodiment shown, the positive mould 5 has a contour in a section (here the side surface 7), which hinders removal from the mould due to its design with respect to the mould-removal direction 32. Accordingly, a volumetric body 10 is arranged on this section, which adjoins this section, continues the volume of the positive mould 5 in the casting formwork 20, and for its part has an outer contour (here the side surface 14), which allows removal from the mould. Insofar as the positive mould 5 must not be destroyed, the volumetric body 10 is necessary with regards to removal from the mould, depending on the shaping of the positive mould 5.

FIG. 2d shows the negative mould 35 consisting of hardened (negative-mould) concrete, which is equipped for pouring with fresh concrete for producing a concrete workpiece 1 (FIG. 1). In turn, the person skilled in the art may apply a suitable separation layer onto the negative mould 35. Here, by means of the structural element 25 cast-in the negative mould 35, with the aid of a screw symbolized by the dot-dashed line 40, a further structural element 41 is arranged on the negative mould in the region of the casting cavity 36, just like a volumetric body 42, which is screwed to the structural element 26 of the negative mould 35 by means of a screw symbolized by the dot-dashed line 43. Therefore, the casting cavity now has the shape of the concrete workpiece 1 (FIG. 1) to be produced, wherein the structural element 41 corresponds to the threaded bush 2 (FIG. 1).

The negative mould 35 can now be filled with fresh concrete up to the level according to the line 44 illustrated dashed.

FIG. 2e shows the negative mould 35 consisting of concrete, in which the fresh concrete is at least hardened partially, i.e. to such an extent and thus the concrete workpiece 1 has formed, that it can be removed from the mould. To this end, first the volumetric body 42 is removed by detaching its screw connection (dot-dashed line 43), see FIG. 2f. Then, the concrete workpiece 1 can be removed from the negative mould 35 in the mould-removal direction 45. If desired, the negative mould 35 can be equipped anew, in that the volumetric body 42 and a new structural element 41 are inserted again. The negative mould 35 is suitable for series production.

A method is created for producing a concrete workpiece 1, in which fresh concrete is poured into a negative mould 35 of the workpiece 1, hardens at least partially in the same and thereafter is removed from the mould, wherein a positive mould 5 is produced of the concrete workpiece to be produced, this positive mould is arranged in a casting formwork 20 and thereafter for its part is poured over with a negative-mould fresh concrete, the negative-mould fresh concrete is removed from the mould after at least partial hardening and the concrete body produced in such a manner is used for its part as a negative mould 35, in order to produce the workpiece 1 therein by means of the fresh concrete in the negative mould 35.

FIG. 3a shows a workpiece produced according to the invention, to scale, namely a gearwheel 60 with a radius of 800 mm, a gear rim 61, a hub 62 and spokes 63. By means of the gearwheel 60, a heliostat, which is arranged on the same and not illustrated so as to make the figure clearer, is pivoted for the tracking of the sun. The pivoting movement is approx. 15°/min, is triggered by means of a pinion meshing with the gear rim 61 and must take place precisely, wherein the connection of the gearwheel 60 to the heliostat must transmit the pivoting movement to the same just as precisely. Accordingly, the manufacturing tolerances are small and have not yet been realized in the prior art for a concrete workpiece.

The gearwheel 60 has a first structural element 64, namely a rotational axis fixed in the hub 62, and second structural elements 65 at the end of the spokes 63, which are constructed as bushes, which accommodate positioning pins of the heliostat arranged on the gearwheel 60 and transmit the rotational movement to the same.

FIG. 3b shows the region 65 marked by dashes in FIG. 3a as an enlarged detail drawing. In the gear rim 61, the height of the teeth is 10 mm, the tooth spacing is 18 mm.

FIG. 4a shows a casting shell 70 made from iron plate equipped according to the invention, in which a positive mould 71 of the gearwheel 60 (FIGS. 3a and 3b) is arranged, which is made from wood up to the positive mould of the gear rim 72 (FIGS. 3a and 3b). The positive mould 72 consists of plastic, nylon here. Structural elements 73 for the positive mould, which are constructed as bushes, are arranged in the positive mould 71, which are cast in the negative mould to be poured subsequently and remain in the same.

In addition to the positive mould 71, contour elements 78 are arranged in the casting shell 70, which have the outline of further structural elements 75 or tools 76 and thus enable space for the arrangement of structural elements and tools in the negative mould, see FIG. 5a to this end.

FIG. 4b shows the region 77, marked by dashes in FIG. 4a, as an enlarged detail drawing.

FIG. 5a shows a concrete negative mould 80, created by pouring negative-mould fresh concrete into the casting shell (FIG. 3a, b). The further structural elements 73 constructed as bushes can be seen, which are cast into the concrete of the negative mould 80, and the negative mould of the gear rim 81 and the negative moulds of the contour elements 82 with the negative moulds of the tools 83. A negative mould for the production of a concrete workpiece is created, produced according to the above-described method, which consists of concrete at least to some extent (see below in this regard). This negative mould has cast structural elements and preferably recesses for tools, wherein the structural elements for a detachable connection are preferably constructed with volumetric bodies and/or structural elements of the concrete workpiece (see also the description for FIGS. 2b and 3a in this regard).

FIG. 5b shows the region 84 marked by dashes in FIG. 5a as an enlarged detail drawing. The negative mould of the gear rim 81 has virtually vertical side walls 85, 86. It is noted here that such a negative mould 80 can easily be produced by casting, wherein the production of a negative mould, from aluminium for example, with the same contour as the negative mould of the gear rim by cutting would be problematic and complicated.

The outlay for a positive mould 71 with a casting shell 70 (FIG. 4a) is approximately a quarter of that for an aluminium negative mould according to FIG. 5a, wherein it is then to be assumed that the negative mould of the gear rim 81 would have to be changed in order to be able to produce the aluminium negative mould at all. The outlay for ten negative moulds 80 (FIG. 5a) is in turn approximately a quarter of the outlay for an aluminium negative mould. Should small series of perhaps several hundred pieces be produced, that can only be done with high outlay using an aluminium negative mould, but easily using the concrete negative moulds produced according to the invention: As a plurality of negative moulds are available, long (parallel) hardening times for the concrete workpiece (here the gearwheel 60) are possible—this saves expensive concrete mixtures for fast (serial) hardening time and the outlay for the cooling respectively necessary for a fast hardening time. Overall, the production is considerably simplified and made considerably less expensive, not only with regards to the concrete negative moulds, but rather also for the subsequent production of the series parts.

In an embodiment not illustrated in the figures, the negative mould is to some extent realized from concrete and to some extent from a different material, for example metal, for example if the metal part can be produced very easily and a complicated shape is provided for a part of the workpiece. Then a method is created according to the invention, in which the positive mould is partially formed and a negative-mould volumetric body and a negative-mould section made from a different material than concrete are produced for the missing part, and wherein for the casting of the concrete workpiece, the negative mould connected to the negative-mould section made from a different material is used. Then, the concrete negative mould according to the invention has a section made from a different material than concrete.

1. A method for producing a concrete workpiece (1, 60), in which fresh concrete is poured into a negative mould (35, 80) of the workpiece (1, 60), hardens at least partially in the same and thereafter is removed from the mould, characterized in that a positive mould (5, 71) is produced of the concrete workpiece (1, 60) to be produced, this positive mould is arranged in a casting formwork (20, 70) and thereafter for its part is poured over with a negative-mould fresh concrete, the negative-mould fresh concrete is removed from the mould after at least partial hardening (35, 80) and the concrete body produced in such a manner is used for its part as a negative mould (35, 80), in order to produce the workpiece (1, 60) therein by means of the fresh concrete poured into the negative mould (35, 80).

2. The method according to claim 1, wherein the positive mould (5) has a contour in a section, which hinders removal from the mould due to its design with respect to the mould-removal direction (32), and wherein a volumetric body (10) is arranged on this section, which adjoins this section, continues the volume of the positive mould (5) in the casting formwork (20), and for its part has an outer contour, which allows removal from the mould.

3. The method according to claim 1, wherein structural elements (25, 26, 73) are arranged on the positive mould (5, 71) in a detachable manner, which encloses the negative-mould fresh concrete during casting, and wherein the structural elements (25, 26, 73) are detached from the positive mould (5, 71) in such a manner for the removal of the negative mould (35, 80) from the casting formwork (20, 70) that the structural elements (25, 26, 73) remain in the negative mould (35, 80).

4. The method according to claim 1, wherein, in addition to the positive mould (71), contour elements (72) are arranged in the casting formwork (70), which enable space for the arrangement of tools in the negative mould (80).

5. The method according to claim 1, wherein the positive mould is partially formed and a negative-mould volumetric body and a negative-mould section made from a different material than concrete are produced for the missing part, and wherein for the casting of the concrete workpiece, the negative mould connected to the negative-mould section made from a different material is used.

6. A negative mould for the production of a concrete workpiece, produced according to the method of claim 1, characterized in that it at least partially consists of concrete.

7. The negative mould according to claim 6, which has cast structural elements (25, 26, 73) and preferably recesses (72) for tools, wherein the structural elements (25, 26, 73) are preferably constructed for a detachable connection to volumetric bodies (10) and/or structural elements of the concrete workpiece.

8. The negative mould according to claim 6, which has a section made from a different material than concrete.
